(19) United States
(12) Patent Application Publication
(10) Pub. No.: US 2011/0253761 A1
(43) Pub. Date: Oct. 20, 2011

(54) CUTTING MEANS AND A DISPENSER COMPRISING CUTTING MEANS

(76) Inventor: Mikael Glatzl, Askim (SE)

(21) Appl. No.: 12/999,000

(22) PCT Filed: Jan. 19, 2010
(86) PCT No.: PCT/EP2010/050569

§ 371 Date: Jun. 22, 2011

(30) Foreign Application Priority Data
Jan. 29, 2009 (EP) 09151666.6

(51) Int. Cl. A47K 10/38; B26D 1/02

(52) U.S. Cl. 225/53; 225/91

(57) ABSTRACT

Cutting means (110) for use with a dispenser for a centre-fed roll of web material, said cutting means comprising a support structure (200), a plurality of protrusions (202) provided at said support structure, wherein at least some of said plurality of protrusions (202) has a rounded tip (300e) and neighbours at least one other protrusion (202) having a rounded tip (300e), and a cutting edge (302a; 302b) provided between said rounded tips of said neighbouring protrusions. An extraction means and a dispenser comprising cutting means are also defined.

### FIELD OF THE INVENTION

The present invention relates to a cutting means for use with a dispenser for a centre-fed roll of web material, said cutting means comprises a support structure and a plurality of protrusions provided at said support structure. The present invention also relates to a dispenser for a roll of web provided with such a cutting means.

### BACKGROUND OF THE INVENTION

Dispensers for web material such as tissue paper or nonwoven material intended for wiping purposes are widely used in public premises, industrial applications as well as in private households.

A typical dispenser for a centre-fed roll of paper comprises a housing with a base plate for supporting the roll. An opening is provided in the base plate permitting paper to be pulled out of the dispenser. Furthermore, there is a tear-off edge arranged underneath the base plate, wherein the tear-off edge is provided with a set of sharp tear-off teeth against which paper pulled out of the dispenser can be torn off.

However, there seem to be a need for an improved arrangement for tearing off the web-material from a centre-fed roll.

### SUMMARY OF THE INVENTION

In view of the above, an object of the invention is to provide an improved arrangement for tearing or cutting off web material from a centre-fed roll of web material.

An improved cutting means for a dispenser for a centre-fed roll of web material in accordance with a first aspect of the present invention is defined in claim 1. Said cutting means comprises a support structure, a plurality of protrusions provided at said support structure, wherein at least some of said plurality of protrusions has a rounded tip and neighbours at least one other protrusion having a rounded tip; and a cutting edge provided between said rounded tips of said neighbouring protrusions.

The cutting means according to the present invention may e.g. be used for a dispenser for a roll of centre-fed web such as tissue paper or non-woven material. Tissue paper may for example be soft absorbent paper that may be creped or non-creped. Tissue paper may comprise fibres of pulp and also other fibres. Tissue paper in a roll may comprise one or several layers of material. The Nonwoven materials are typically materials that have been manufactured by putting small fibres together in the form of a sheet or web, and then binding them either mechanically, with an adhesive, or thermally. Non-woven material, paper and tissue paper may be suitable for different applications such as moist towelette, cloth, toilet and kitchen paper or other forms of wiping material.

In many situations web material is pulled out peripherally from a roll, and torn against a straight tear-off edge having a length corresponding to the width of the web material. However, as web material is pulled out from a centre-fed roll, the web material is gathered why the tear-off edge must penetrate and tear or cut through several layers of web material at the same time. Thus, the tearing edge in prior art is conventionally provided with a set of sharp tear-off teeth configured to penetrate multiple layers of web material and tear it off.

The present invention is based on the surprising finding that it is possible to utilize protrusions having a rounded tip portion and cutting off web material from a centre-fed roll by providing a cutting edge between or intermediate the tips of the protrusions.

As the cutting means according to the invention does not require the tip of the protrusions to penetrate and tear the web material, the shape of the tip of the protrusion can be designed such that a user may draw his finger over the tips of the protrusions without hurting his finger. Hence, an advantage with using protrusions with a rounded tip is a reduced risk of scratching or hurting one's hand on the cutting-off means. At the same time, the web material may be cut by the cutting edges provided behind the outermost part, i.e. the tips, of the protrusions. An advantage associated herewith is that as the risk that one's fingers may access the cutting edge is reduced, a sharper cutting edge may be utilized. Hence, an improved cutting effect of the web may be obtained. A further advantage with using a cutting edge instead of tear-off teeth is reduced splintering of the web material and thereby reduced dust.

Neighbouring protrusions should in this exemplary embodiment be understood as that there is no other protrusion arranged between neighbouring protrusions.

According to one exemplary embodiment, the protrusions may preferably be arranged sufficiently close to prevent that one can reach the cutting edge with one's fingers. By this a user may draw his finger over the tips of the protrusions without hurting his finger. Preferably, the distance between adjacent or neighbouring teeth is 10-3 mm, more preferred 8-4 mm and most preferred 5 mm. With these ranges of distances between the tips of adjacent protrusions, a user will not easily or accidentally access the intermediate cutting edges with his or hers fingers, since the fingers will in most cases contact at least two protrusions at the same time when pressed against the cutting means. A smaller distance between adjacent protrusions has also the advantage that the finger of a user in most cases will contact the tips of more than two protrusions at the same time. By this, the risk is further reduced that the user will hurt him or her on the tips of the protrusions. This is due to the fact that the pressure of the finger against the tips is divided among several tips and not only one. It is therefore possible for a user to initiate the extraction of web material from a dispenser by pushing e.g. his or hers thumb against the web material and further against the protrusions without getting hurt. By a sliding movement downwards in the path of the web, i.e. against the protrusions, the web is brought along and moved downwards.

The desired amount of protrusions depends on the specific web material and situation the cutting means is intended to be used in. However, according to one exemplary embodiment, the cutting edge comprises between 8 and 15 protrusions, and more preferred 10 to 13 protrusions and most preferred 11 protrusions. These numbers of protrusions may be suitable in order to obtain a cutting means that is able to hook the web and bring it towards the cutting edges. With hooking the web is meant that when a user intends to cut the web, he or she may bring the path of the web towards the tips and the intermediate cutting edges. The web is thereby hooked on the tips and stopped so that more web material is not fed out from the roll.

According to one exemplary embodiment, the protrusions have the same dimensions, at least in one direction. According to another exemplary embodiment, the protrusions have the same dimensions in all directions. According to yet another exemplary embodiment, the protrusions have the same dimensions and shape in all directions. All protrusions of the cutting means may then be seen as describing an uninterrupted or continuous row of similar protrusions extending from the support structure. However, it is also possible to have interruptions in the series of the protrusions with rounded tips, e.g. so that certain protrusions have a different shape or size or is not provided with rounded tips.

It has been described that the tip portion of the protrusion has a rounded shape. This rounded shape may be provided as a rounded shape in one or several dimensions. Hence, it is not necessary to have a completely round or spherical tip.

According to one exemplary embodiment, the height of the support structure is between 6 mm and 40 mm, and more preferably between 10 and 20 mm most preferred about 12 mm. A lower support structure provides for a more compact dispenser, when the cutting means are provided at a dispenser, whereas a higher support structure may reduce the risk that the web falls out of the support structure and becomes inaccessible for the user. With falling out of the support structure is meant that the web being extracted from the roll does not reach the cutting means, i.e. it is positioned inside the dispenser at a level above the cutting means.

According to one exemplary embodiment, the support structure may be in a circular form. However, it does not necessarily circumscribe the whole perimeter of a circle. It may then have a diameter of approximately 20-40 mm, and the protrusions may protrude from the support structure with a length of e.g. 4-7 mm and more preferred 5-6 mm. In this case, the opening through which the web may be dispensed may be between 6 and 32 mm, more preferred between 20 and 30 mm. However, the diameter may vary depending on the web of the dispenser for which the cutting means is intended to be used.

It may be suitable that each protrusion has a base surface and a slide surface, wherein said slide surface extends from said support structure to a point on said base surface most remote from said support structure. In this embodiment said slide surface extends from said support structure to a point on said base surface most remote from said support structure. Preferably, said base surface does also extend from said support structure. Hence, the tip portion is the point where the slide surface meets or is connected to said base surface remote from the support structure. The slide or glide surface may be provided so that it faces the path of the web material as the web is being pulled out of a roll of web material. By this, the web material may slide or glide on the slide surface as it is being dispensed from the roll. Hence, the slide surface guides the web material as it is being extracted from the roll.

The slide surface may take on many different shapes and extensions. The purpose of the slide surface is that the web material shall be able to slide on it without being cut, torn or ripped, as it is being dispensed from a dispenser. According to one exemplary embodiment, the slide surface may be in the form of narrow surface or an edge. However, in order for the web material to be able to slide or glide on the slide surface, it is important that the edge is not too sharp so that it tears or damages the web.

According to one exemplary embodiment, the width of the slide surface is in the range of 0.2-1.2 mm, more preferably 0.3-0.8 mm, and most preferably 0.4-0.6 mm. According to one exemplary embodiment, the width of the slide surface is decreasing, starting with one width close to the support structure and gradually narrowing towards the tip portion.

In an exemplary embodiment, the slide surface does not have to be a planar surface, but may instead be a curved surface with a convexity directed away from said base surface. Hence, the slide surface may be seen as a ridge or crest with a convex shape in a direction away from the base surface. Another way to describe the slide surface according to this exemplary embodiment is that it is a narrow surface with rounded corners, as seen from the tip of the protrusion. This shape may be beneficial in terms of not tearing or damaging the web which should be able to slide on the slide surface as it is being extracted from a roll.

According to one exemplary embodiment, the base surface is substantially planar. According to another exemplary embodiment, the base surface has a slight concave shape. A concave shape means in this case that the base surface, when the cutting means are arranged in relation to a dispenser, is curved inwards towards the dispenser holding the web.

According to one exemplary embodiment, the base surface extends from the support structure with an angle that is substantially perpendicular. It may be preferred that the deviation from the substantially perpendicular relationship between the base surface and the support structure is preferably less than 5° in either direction, more preferred less than 3° in either direction and most preferred less than 1° in either direction.

It may be preferred that the cutting edge is provided at a portion of said base surface.

According to one exemplary embodiment, the cutting edge is provided at a portion of said base surface. Hence, the cutting edge may be provided at each of said protrusions. Furthermore, a base surface may have two cutting edges, one on each side of said base surface, as seen from the tip of said protrusion. When studying a protrusion from a side view, the tip portion will be provided furthest away from the support structure and thereafter the cutting edge will follow. Hence, the cutting edge or cutting edges on one or each of said sides are closer to the support structure than the rounded tip portion. According to one exemplary embodiment, the cutting edge or cutting edges start immediately behind the outermost rounded tip of said protrusions.

Providing the cutting edges at the edges of the base surfaces of the protrusions is beneficial. It positions the cutting edges close to the tip portions which the web passes when it is being dispensed from the roll, hence making the distance the web has to be moved to become cut short. Furthermore, it provides a good utilisation of material already included in the cutting means.

However, according to another exemplary embodiment, the cutting edges are separate cutting edges, extending between the bases of two neighbouring protrusions. With base of protrusion is intended to mean the portion of a protrusion that is closest to the support structure. In this embodiment the cutting edges may instead be provided as separate means between each or some of the protrusions. According to one exemplary embodiment, the cutting edges may have a substantially straight extension. According to one exemplary embodiment, the cutting edge is positioned 2-10 mm behind the rounded tip portion of the protrusion.

According to one exemplary embodiment, the cutting edges of the cutting means are provided at the same plane as the base surfaces of each of the protrusions. This position of the cutting edges may be achieved both when the cutting edges are provided at or constituted of the base surfaces of the protrusions, but also when they are provided as separate means between adjacent protrusions. In these cases, the cutting means of the present invention cuts the web at the plane of the base surface. In order for a user to access the web the next time it is desired to extract a portion of the web from a dispenser, it may then be beneficial if it is provided for the user to grip the web at a level above the base surface of the cutting means. The meaning of above should be interpreted as earlier along the path of the web as it exits a dispenser, i.e. before the web reaches the base surface of the cutting means. If the cutting means are provided at the bottom portion of a web dispenser, above has its normal meaning. However, the cutting means may also be provided at the top portion of a web dispenser, and above is in that case understood to mean closer to the roll of web material, i.e. in a direction towards the inside of the dispenser the cutting means is being used with. This possibility of accessing the web may be provided in a number of alternative manners. According to one exemplary embodiment, the access opening may be provided in the form of a globe or cup. The cup may be provided so that its convex side extends into the dispenser to which the cuttings means are provided. The cup may further have e.g. a substantially circular shape, but have a cut-out or opening facing the cutting means so that a user may insert a finger and grab the web above the cutting plane of the cutting means.

In another exemplary embodiment the cutting means may be provided so that they are accessible for a user without an access cut-out or opening in the bottom of the dispenser to which the cutting means are arranged. This may e.g. be the case if the cutting means are arranged below a bottom surface of the dispenser the cutting means are being used with. However, the dispenser may still be provided with an opening for the web to pass through.

Preferably, said plurality of protrusions further comprises first and second side surfaces connecting said slide surface with said base surface, wherein said cutting edge is provided at the intersection between at least one of said side surfaces and said base surface on each protrusion. Hence, side surfaces extend from the base surface to the slide surface.

According to one exemplary embodiment, said side surfaces have a straight or planar extension from said base surface to said slide surface.

According to one exemplary embodiment, said cutting edge may be provided at the edge or intersection between said side surface and said base surface.

According to one exemplary embodiment, said side surfaces extend from a base surface and connects to said slide surface. Said slide surface does not have to be a planar surface, but may instead be a curved surface connecting the two side surfaces with each other. Hence, the slide surface may be seen as a ridge or crest with a convex shape in a direction away from the base surface.

In one exemplary embodiment, the rounded tip of each of said protrusions has a curvature in the plane of the base surface, said curvature having a radius in the range of 0.2-1.2 mm, more preferably in the range of 0.4-0.8 mm and most preferably 0.6 mm.

With the phrase curvature in the plane of the base surface is meant a curvature as seen from above or below of each of the protrusions. In this embodiment, the curvature of the rounded tip in the plane of the base surface is a convex curvature. Hence, the rounded tip has its rounded surface pointing in the extension direction of the protrusion, as seen from the support structure. This curvature is beneficial since it assists in providing a tip of each of the protrusions that may be touched by a user without hurting the user. Furthermore, the curvature assists in not damaging the web as the web passes the tip when it is being dispensed from the roll of web.

According to one exemplary embodiment, the width of the slide surface is substantially equal to the radius of the curvature in the plane of the base surface.

In one exemplary embodiment, the rounded tip of each of said protrusions has a curvature in a plane perpendicular to the plane of the base surface, said curvature having a radius in the range of 0.2-1.2 mm, more preferably in the range of 0.3-0.8 mm, and most preferred 0.4 mm.

A rounded tip in a plane perpendicular to the plane of the base surface is intended to mean a plane as seen from the side of one of the protrusions. Hence, the rounded tip in this exemplary embodiment is provided in a plane that is also perpendicular to the plane of the support structure. In this embodiment, the curvature of the rounded tip in the plane perpendicular to the base surface is a convex curvature. Hence, the rounded tip has its rounded surface pointing in the extension direction of the protrusion or the slide surface of the protrusion, as seen from the support structure. This curvature is beneficial since it assists in providing a tip of each of the protrusions that may be touched by a user without hurting the user. Furthermore, the curvature assists in not damaging the web as the web passes the tip when it is being dispensed from the roll of web.

According to some exemplary embodiments the support structure does not have a straight extension. In those embodiments, the plane of the support structure is meant a plane where the respective protrusion is connected to the support structure.

According to one exemplary embodiment, the slide surface extends from the base surface and towards the support structure. The curvature as seen in a plane perpendicular to the plane of the base surface may therefore be provided at said slide surface adjacent its connection to the base surface. Hence, this curvature may be a convex curve of the slide surface. With convex curvature is in this embodiment meant to be a curvature having a pointing away from the base surface and/or the support structure.

According to one exemplary embodiment the slide surface may extend in a direction that is perpendicular to the base surface. In that case, the slide surface does not necessarily have to be provided with a curvature adjacent its connection to the base surface. A slide surface being arranged perpendicularly to the base surface may, in certain embodiments, also be parallel to the support structure.

According to one exemplary embodiment, the tip portion has a curvature within the ranges given above in both the plane of the base surface and the plane perpendicular to the base surface. Such a rounded tip is friendly to both a user and the web being dispensed from the roll. According to one exemplary embodiment, the radius of the curvatures in both the plane of the base surface and the plane perpendicular to the plane of the base surface are similar, within the ranges given above.

According to one exemplary embodiment, the width of the slide surface is substantially equal to the radius of the curvature in the plane that is perpendicular to the plane of the base surface.

According to one exemplary embodiment, an edge formed between the slide surface and the base surface at the tip of the protrusion has an angle being in the range 45°-95°, more preferably 85°-95°, and most preferred 90°.

The tip portion of each of the protrusions has according to one aspect of the invention a rounded shape. However, it may be beneficial to provide the connection between the slide surface and the base surface with a non-rounded edge, even though the tip has a rounded shape. Such an edge may then be used to hook the web onto, when a user pulls the web towards the cutting edges. Hence, when a user pulls the web towards the tips of the protrusions and towards the cutting edges, the web gets hooked onto these non-rounded edges and stops in a position where it may be cut by the cutting edges.

According to one exemplary embodiment, the edge is preferably provided in a plane that is perpendicular to the plane of the support structure.

The edge being in the ranges given above is preferably arranged below, as seen in the path of the web being dispensed from the roll, a convex curvature of the slide surface in the plane perpendicular to the plane of the base surface. This may be advantageous since a web being pulled straight out from a roll may then slide on the slide surface, including the convex curvature, and not being ripped, torn or hooked on the edge where the slide surface meets the base surface. However, when a user wants to cut the web, he or she may alter the direction of the path of the web towards the edge between the slide surface and the base surface and then the paper gets caught on the edge between the slide surface and the base surface.

In order to achieve this non-rounded edge, a potential convex curvature, as in certain exemplary embodiments, of the slide surface must be chosen so that a non-rounded edge is achieved in the connection between the slide surface and the base surface.

According to one exemplary embodiment, a radius of the curvature of the slide surface adjacent its connection to the base surface, in a plane that is perpendicular to the base surface and perpendicular to the plane of a support structure, is chosen so that the slide surface meets the base surface with an angle that is between 85°-95°, more preferable 88°-92° and most preferred 90°.

An angle of the connection between the base surface and the slide surface is beneficial since it, together with the rounded shape of the tips, creates a tip that is friendly towards a user but at the same time may hook or stop the web when the path of the web is altered towards the cutting edges. An angel that is approximately 90° has proven to be beneficial since it is a sufficient angle to hook the web so that the web is stopped by an adjustment of the angle of the path of the web.

According to one exemplary embodiment, when web material is being pulled out of roll, it is being pulled substantially straight out of the roll. Hence, with a centre-fed paper, it is being pulled substantially perpendicular to the winding of the roll. The web may then slide on the slide surfaces and pass through or by the cutting means. When the web is to be cut a user alters the direction of the path of the web. It may then be beneficial that the angle between the slide surface and the path of the web is 95° or less, once the user has altered the path of the web. By this a beneficial hooking of the web onto the edges of the protrusions may be achieved.

Preferably, a distance between said slide surface and said base surface decreases continuously from the support structure to the tip of the protrusion. Such an arrangement provides for a slide surface on which the web may be guided as it is being dispensed from a roll.

According to one exemplary embodiment, the slide surface is arranged as a straight line extending between the support structure and the tip portion where it connects to the bottom surface. Hence, in order for the distance between the slide surface and the base surface to decrease continuously or gradually from the support structure to the tip of the protrusion, the slide surface is beneficially connected to the support structure above the level of the tip, as seen in the path of the web as the web is being dispensed from the roll

According to another exemplary embodiment, the slide surface has a concave shape, at least along a portion of its extension between the support structure and the connection to the base surface. A concave shape may provide enhanced ergonomics and improve the user experience.

According to one exemplary embodiment, the slide surface has an extension that is angled with respect to the base surface. This angle may preferably be between 10° and 90°, more suitable between 20° and 70° and most suitable between 60° and 70°. These ranges of angles have proven to be beneficial in terms of providing a surface on which a web being dispensed from a roll may slide. The larger angle between the base surface and the slide surface, i.e. up to but not exceeding 90°, is also beneficial in terms of lessen the risk of hurting the user as he or she dispenses the web from its roll.

According to another exemplary embodiment, the slide surface may extend in a direction that is perpendicular to the base surface. A slide surface being arranged perpendicularly to the base surface may, in certain embodiments, also be parallel to the support structure.

According to yet another exemplary embodiment, the angle between the slide surface and the base surface may in fact exceed 90° and may e.g. be up to 120°. Such an embodiment may e.g. be beneficial when the cutting means are provided substantially below a dispenser. Hence, a situation where a user may pull the web upwards, i.e. in the direction towards the dispenser when it is intended to cut the web. In this embodiment, the web may be in contact with the slide surfaces as it is being pulled out from the roll, in a substantially straight direction. Furthermore, when a user intends to cut the web, the path of the web may be altered so that the angle between the slide surface and the path of the web is 95° or less, once the user has altered the path of the web. By this a beneficial hooking of the web onto the edges of the protrusions may be achieved in an exemplary embodiment where the angle between the slide surface and the base surface is up to maybe a 120°.

As described above, the slide surface may in an exemplary embodiment have a concave shape. A concave shape means in this case that it is being curved towards the base surface. When a protrusion is viewed from the side, the slide surface may then resemble e.g. a ski slope. When the slide surface has a concave shape, a tangent to the slide surface extending from the support structure to the tip portion of the protrusion may have an angle in relation to the base surface within the range given above, i.e. between 10° and 90°, more suitable between 20° and 70° and most suitable between 60° and 70°. Furthermore, it is possible to consider the concave shape of the slide surface as a line extending through a plurality of planes. In that case, the planes may have an angle in relation to the base surface within these ranges.

However, according to another exemplary embodiment, the distance between the slide surface and the base surface does not decrease continuously between the support structure and the tip. It is for example possible to have a slide surface being substantially parallel with the base surface. Such a slide surface may in an exemplary embodiment have a convex curvature in a plane perpendicular to the plane of the base surface adjacent its connection to the base surface. The web being dispensed from a roll may then slide on this convex curvature without being damaged. Also in this exemplary embodiment, the convex curvature of the slide surface adjacent its connection with the base surface is preferably between 0.2-1.2 mm, more preferred between 0.4-0.8 mm and most preferred 0.6 mm.

According to one exemplary embodiment, the base surface does not need to have a straight or planar extension. The angle between the slide surface and the base surface is then meant to be considered as the general extension of the slide surface in relation to a general extension of the base surface. For example, if the base surface has a convex shape in the direction towards the slide surface, its general extension is understood the mean a plane from which the convexity extends.

According to one exemplary embodiment, said base surface of each of the protrusions has the shape of a triangle with an angle at the tip of the protrusion in the range 35° to 75°, more preferably in the range 45° to 65°, and most preferred 55°.

The angle referred to above is as seen in the plane of the base surface, i.e. as seen from above or below the base surface. According to one exemplary embodiment, the base surface has the shape of an isosceles triangle where the sides of the base surface that intersects with the side surfaces have equal length. According to another exemplary embodiment, the base surface has the shape of a right-angled triangle. According to yet another exemplary embodiment, the base surface has rectangular shape.

Furthermore, according to one exemplary embodiment, the cutting edge does not have to extend along a straight line and instead of having a V-shaped recess, there may be a U-shaped recess between the protrusions. According to another exemplary embodiment, there is instead provided rectangular protrusions with an intermediate cutting edge. According to yet another exemplary embodiment there is alternately provided protrusions with rectangular and triangular base surfaces.

According to one exemplary embodiment, each or some of said side surfaces of the protrusions are provided with a concave shape.

According to another exemplary embodiment, said side surfaces are provided with a concave shape. According to one exemplary embodiment, the concavity extends towards the centre of the protrusion. Hence, it may be seen as a cut-out of a substantially planar side surface, and i.e. when looking at the protrusion from the tip or the support structure, the side surfaces do in this exemplary embodiment have a surface resembling a ski slope. According to one exemplary embodiment, the concavity may have a radius of between 0.1 to 2 mm. According to one exemplary embodiment, the diameter of the concavity of the side surfaces increase along the extension of the protrusion, as seen from the tip to the support structure.

A concave shape of the side surfaces has several advantages. Firstly, it may assist in creating a sharp cutting edge between the tip portions of each protrusion in those embodiments where the edge between a side surface and a base surface constitutes a cutting edge. This is because there is less material at the side just above the base surface and this assists in creating a sharp edge at the connection between the base surface and the side surface. Secondly, it is also beneficial in that it provides more space between adjacent protrusions, as compared to straight side surfaces. By this, more web material may be inserted between each protrusion and thereby become cut by the cutting edges. Thirdly, it may for certain embodiments provide benefits in terms of production of the protrusions or the cutting means.

The less material or the smaller angle that is achieved between the faces of the cutting edge of the base surface is beneficial. However, when the edge is sharper it may also become more susceptible of wearing out and it is therefore beneficial to provide it with a cutting edge that is beneficially sharp but at the same time has a desired expected life-length.

According to another exemplary embodiment the side surfaces extend substantially perpendicular from the base surface and to the slide surface. According to one exemplary embodiment, the slide surface covers a smaller area than the base surface, and the side surfaces extend substantially perpendicular from the base surface and to the slide surface. However, the side surfaces do not extend from the perimeter of the base surface. The base surface may in these exemplary embodiments have a small height, providing for a sharp cutting edge on the perimeter of the base surface. It is possible to provide the side surfaces in these exemplary embodiments with a concavity. However, the benefits of providing a sharp cutting edge on the edge of the base surface and to provide for more space for between adjacent protrusions is achieved even without a concave shape of the side surfaces.

According to another aspect of the present invention, a paper extraction means comprising an opening for leading through web material from a centre-fed roll, and cutting means in accordance with what has been described above.

The different embodiments of a cutting means that has been described above may be arranged together with an opening and provided at e.g. a dispenser.

According to one exemplary embodiment, cutting means may be provided in a circular form. However, it does not necessarily circumscribe the whole perimeter of a circle. It may then have a diameter of approximately 20-40 mm, and the protrusions may protrude from the support structure with a length of e.g. 4-7 mm and more preferred 5-6 mm. In this case, the opening through which the web may be dispensed may be between 6 and 32 mm, more preferred between 20 and 30 mm. However, the diameter may vary depending on the web of the dispenser for which the cutting means is intended to be used.

According to another exemplary embodiment, the cutting means may be provided at a substantially planar support structure and the opening may be provided at one side of said support structure. The protrusions may then protrude from said support structure towards the path of the web being extracted from said opening.

According to another aspect of the present invention there is provided a dispenser for a roll of web material comprising:

a housing for accommodating the roll, wherein the housing has a through-hole or opening for enabling extraction of the web material from said housing; and

cutting means according to what has been described above, and wherein said cutting means is arranged at said opening in such a way that said web material may be cut off by said cutting means.

A dispenser being provided in this manner provides a suitable dispenser for tearing or cutting off web-material from a centre-fed roll of web material.

The cutting means may not necessarily be provided at the bottom portion of a dispenser. Instead, it is e.g. possible to have a dispenser that is adapted to be standing on e.g. a table or a shelf, and the cutting means may then be provided at e.g. the top of the dispenser. In that case, the cutting means or dispenser may comprise means that prevents the web from falling into the dispenser due to gravity. According to one exemplary embodiment of a cutting means adapted to be provided at the top portion of a dispenser, the means for preventing the web from falling into the dispenser may be in the form of an elastic membrane with a slit through which the web passes from the dispenser to the cutting means. The elastic membrane may e.g. be a silicone membrane.

According to one exemplary embodiment, the dispenser is provided with an opening or a trough-hole for enabling extraction of or pulling out of web material from the dispenser.

According to one exemplary embodiment, cutting means may be provided in a circular form and arranged so that they circumscribe the opening of the dispenser. However, the cutting means does not necessarily circumscribe the whole perimeter of a circle.

According to one exemplary embodiment, said dispenser is provided with a through-hole, through which the web material passes as it is being extracted from said dispenser, wherein the diameter of said through-hole is provided so that the web material comes into contact with an edge of the through-hole as it is being extracted from said dispenser, whereby friction is generated between the web material and the edge.

According to one exemplary embodiment, the opening through which the web may be dispensed may be between 6 and 32 mm, more preferred between 20 and 30 mm. However, the diameter may vary depending on the web of the dispenser for which the cutting means is intended to be used.

A friction between the web and the trough-hole is beneficial since it further enhances the possibility of stopping or hooking the web onto the protrusions when a user intends to cut the web.

According to one exemplary embodiment, said trough-hole is constituted by said opening for enabling extraction of the web material from said housing.

According to one exemplary embodiment, the cutting means are fixedly connected to or made integral with at least a portion of the dispenser. In this embodiment, the trough-hole may be formed or be defined by the support structure of the cutting means.

According to one exemplary embodiment, the base surface of the cutting means forms the bottom surface of a dispenser, as seen in the path of the web as it is being dispensed from the dispenser. Hence, in this embodiment the support structure extends into the inside of the dispenser.

According to one exemplary embodiment, the cutting means may be provided in a circular form and arranged so that they circumscribe the opening of the dispenser and the support structure extends into the inside of the dispenser. However, the cutting means does not necessarily circumscribe the whole perimeter of the trough-hole, but the support structure defines the through-hole, at least partly.

According to another exemplary embodiment, a surface or area defining or being arranged adjacent the through-hole may be provided with means for generating additional friction when pulling paper out of the dispenser. According to one exemplary embodiment, the friction means provided at the surface circumscribing the through-hole may typically be a set of grooves or projections.

According to another exemplary embodiment, the friction means may also be in the form of a friction generating material, such as e.g. silicone, provided at the surface surrounding the through-hole. The friction means could e.g. be provided completely around the opening or e.g. at only a portion of the surface circumscribing the opening. In one exemplary embodiment, the portion of the surface where the user introduces paper when loading a new roll into a dispenser has low friction, whereas the remaining area is provided with friction means.

According to one exemplary embodiment, said cutting means is arranged in such a way that the web exits the dispenser in a close relationship to the protrusion of the cutting means, i.e. the path of the web material is sufficiently near the protrusion so that the web material may be in contact with at least some of the slide surfaces of said cutting means.

It has proven beneficial that the web exits the dispenser in a close relationship to the protrusions of the cutting means. Put in other terms, the cutting means are preferably arranged in the proximity of the opening of the dispenser. The reason for this being that a more beneficial hooking angle may then be achieved. If the web is pulled straight out of the dispenser and through the cutting means, it may slide on the slide surfaces. However, when the user pulls the web towards the cutting edges of the cutting means, i.e. alter the path of the web, it is desirable that the path of the web obtains a sharp angle in relation to the cutting means. By this, the web will easier be hooked on the rounded tips of the protrusions and the risk that the web slides on the tips of the protrusions and eventually is torn is diminished. Hence, in an exemplary embodiment where the support structure is provided in a circular or semi-circular shape, the opening may preferably have a rather small diameter.

According to one exemplary embodiment, the support structure may be in a circular form, even if it does not necessarily circumscribe the whole perimeter. It may then have a diameter of approximately 20-40 mm, and the protrusions may protrude from the support structure with a length of e.g. 4-7 mm, more preferred 5-6 mm. In this case, the opening through which the web may be dispensed may be between 6 and 32 mm, more preferred between 20 and 30 mm.

According to one exemplary embodiment, the diameter of said support structure may be less than one tenth of the diameter of a full roll.

According to another exemplary embodiment, the cutting means may be pivotally or foldable arranged in relation to said dispenser. It may then, on the one hand, be possible to provide the cutting means so that they extend below a bottom surface of the dispenser when the dispenser is in use. On the other hand, it may be possible to fold the support structure towards the bottom surface so that the cutting means does not extend below the bottom surface of the dispenser when the dispenser is not being used, or at least extends below the bottom surface to a lesser degree. The protrusions may suitable be provided on that side of the support structure that is facing towards the dispenser when the support structure is folded towards the bottom surface. According to one exemplary embodiment, the support structure may then cover the opening of the dispenser when it is folded towards the bottom surface. According to one exemplary embodiment, the support structure may e.g. be provided as a straight or only slightly bent surface. An advantage of these exemplary embodiments is that the protrusions may be folded to a not in use position where there is less risk that the protrusions are damaged, and also less risk that a user hurts himself or herself on them. Another advantage is that if the hole or opening of the dispenser is covered, there is less risk that unwanted substances, such as water, dust or dirt, enters into the dispenser.

In an exemplary embodiment where the support structure has a straight or only slightly bent extension, the opening through which the web exits the dispenser may be arranged sufficiently close to the protrusions protruding from the support structure. According to one exemplary embodiment, cutting means are only provided along one side of an opening. Furthermore, the opening may also be sufficiently small so that the web is gathered together when being dispensed.

The required proximity between the cutting means and the cutting means depends on distance between the paper roll and the cutting means. If the distance between the paper roll and the cutting means is long, it may be more beneficial that the paper is close to the cutting means.

According to one exemplary embodiment, said opening and/or said cutting means is configured to allow a user to grip the web material at a level above the base surface of the cutting means.

As described above, according to one exemplary embodiment, the cutting edges of the cutting means are provided at the same plane as the base surfaces of each of the protrusions and hence, the cutting means cuts the web at or in close proximity to the plane of the base surface. In order for a user to access the web the next time it is desired to extract a portion of the web from a dispenser, it is beneficial if it is provided for the user to grip the web at a level above the base surface of the cutting means. The meaning of above should be interpreted as earlier along the path of the web as it exits a dispenser, i.e. before the web reaches the base surface of the cutting means. If the cutting means are provided at the bottom portion of a web dispenser, above has its normal meaning. However, the cutting means may also be provided at the top portion of a web dispenser, and above is in that case understood to mean closer to the roll of web material, i.e. in a direction towards the inside of the dispenser the cutting means is being used with.

The possibility of accessing the web may be provided in a number of alternative manners. According to one exemplary embodiment, the access opening may be provided in the form of a globe or cup. The cup may be provided so that its convex side extends into the dispenser to which the cuttings means are provided. The cup may further have e.g. a substantially circular shape in the plane of the base surface of the cutting means, but have a cut-out or opening facing the cutting means so that a user may insert a finger and grab the web above the cutting plane of the cutting means.

In another exemplary embodiment the cutting means may be provided so that they are accessible for a user without a cut-out or opening in the bottom of the dispenser to which the cutting means are arranged. In an exemplary embodiment, the support structure may e.g. extend below a surface of the dispenser on which the through-hole exits. Hence, the base surface of the protrusions are positioned below the bottom surface of the dispenser. If the support structure of the cutting means does not form a full circle, e.g. are provided in the shape of a circle with a portion cut-out or is provided in the form of a straight or only slightly bent surface, it will be possible to access the web above the base surface of the protrusions.

According to another exemplary embodiment, said dispenser further comprises two complementary parts adapted to be engaged to form said housing and disengaged to enable a roll of web material to be inserted in said housing, wherein one of said complementary parts is provided with a base structure, wherein said opening for enabling extraction of the web material from said housing is provided in said base structure, and a recess extends from said opening to a periphery of said base structure.

According to one exemplary embodiment, the cutting means may be provided at one of said two complementary parts of said dispenser. The cutting means may e.g. be formed in one piece with one of said parts of said dispenser or be attached to one of said parts of said dispenser. According to another exemplary embodiment, a portion of the cutting means may be provided at one of said two complementary parts of said dispenser and another portion of the cutting means may be provided at the other complementary part of the housing of the dispenser. The cutting means may e.g. be formed in one piece with one or two of said parts of said dispenser or be attached to one or two of said parts of said dispenser.

According to one exemplary embodiment, the complementary parts of said dispenser are divisible along a parting line extending through said cutting means being provided at said dispenser.

According to one exemplary embodiment, the complementary parts of said dispenser are divisible along a parting line extending through said opening through which the web may be extracted from the dispenser.

By this, it is possible to provide for opening of the dispenser and dividing of the cutting means simultaneously or at least to remove the cutting means and access the opening which the cutting means are arranged adjacent.

An advantage of these exemplary embodiments is that they facilitate loading of a new roll of paper into the dispenser. This is because a user may then extract a small piece of the web from the roll and guide it through the recess and into the opening at the same time as the roll is being arranged on the surface of the dispenser that is intended to support the roll. This facilitates the guiding of the web into the opening. Thereafter the complementary parts of the housing may be brought together, and since the cutting means are provided at one or both of the complementary parts of the dispenser, the cutting means becomes arranged at their in use position. By this it is possible to load a new roll of web straight into the dispenser, without having to incline the roll against its in use position, as is often the case with prior art dispensers. This is beneficial since it reduces the height that is necessary for the housing of the dispenser. Furthermore, it is simple to position the web in the opening leading from the dispenser to the cutting means.

According to another exemplary embodiment, the recess extending from the opening through which the web should pass when being extracted from said dispenser and to the periphery of the base structure of the dispenser may have a narrowing shape towards said opening through which the web should pass when being extracted from said dispenser. An advantage with such a narrowing shape is beneficial since the web being brought through the recess into the opening may thereby be compressed, if the narrowing of the recess is chosen within appropriate ranges. However, once the web reaches the opening, it may expand again. By this expansion it will not be able to re-enter into the recess and it is positively and safely positioned in the opening through which it later should pass when being extracted from the dispenser. A user may thereafter close the housing by fitting the complementary parts of the housing together. Having a larger opening of the recess at the perimeter of the base structure simplifies for a user to position the web into the recess and further guide it towards the opening from which the web should later be extracted.

According to another exemplary embodiment said base structure is also divisible along a parting plane extending through said opening. According to another exemplary embodiment, said base structure is also divisible along a parting plane extending through said opening and said cutting means. Hence, a portion of said cutting means will be provided on each of the portions of the base structure. According to yet another exemplary embodiment, the portions of said divisible base structure is connected to a respective one of said complementary parts of said housing. Advantages of these exemplary embodiments is that a user may then divide the housing and position a new web roll into the housing and also position a portion of the web through the opening, or the portion of the opening that is provided on a first portion of the base structure. When the other second complementary part of the housing is fitted to the first part of the housing, a portion of the web will extend through the opening and be accessible for a user. Hence, in these exemplary embodiments it is not necessary to provide the base structure with a recess extending from the opening to the perimeter of the base structure.

These exemplary embodiments that simplifies the positioning of the web material trough the opening through which the web is to be extracted may be advantageous when the opening has a rather small diameter, which may be the case in certain exemplary embodiments in order to provide for an increased friction between the web and the edge of the opening or in order to provide for a desired path of the web in relation to the cutting means.

According to one exemplary embodiment, said base structure may be used to support a roll in the housing of the dispenser.

A dispenser in accordance with one aspect of the invention and a dispenser with cutting means and extraction means according to other aspects of the invention may be used as e.g. be a wall-mounted dispenser, a dispenser adapted to be mounted in a shelf or inside a cupboard, a portable dispenser or a dispenser adapted to be standing on e.g. a table. Furthermore, a cutting means in accordance with certain aspects of the invention may also be useful for cutting webs from rolls that are not centre-fed.

According to another aspect of the present invention there is provided cutting means for use with a dispenser for a centre-fed roll of web material, said cutting means comprising: a support structure; a plurality of protrusions provided at said support structure, wherein said protrusions are provided with a tip, and wherein the distance between the tips of neighbouring protrusions are in the range of 2-10 mm, more preferably 3-7 mm and most preferred 4-6 mm; and cutting edges provided between said tips of said neighbouring protrusions.

According to another aspect of the present invention there is provided cutting means for use with a dispenser for a centre-fed roll of web material, said cutting means comprising: a support structure; a plurality of protrusions provided at said support structure, wherein said protrusions are provided with a tip, wherein said tips has a curvature as seen in the path of the web as it is being extracted from a roll of web material.

According to another aspect of the present invention there is provided cutting means for use with a dispenser for a centre-fed roll of web material, said cutting means comprising: a support structure; a plurality of protrusions provided at said support structure, wherein said protrusions are provided with a base surface extending from said support structure and a slide surface extending from said support structure, wherein said slide surface extend with an angle to said base surface so that a tip of said protrusion is formed where said slide surface meet said base surface remote from said support structure.

According to another aspect of the present invention, there is provided a cutting means for a dispenser for a centre-fed roll of web material, said cutting means comprising: a support structure, a plurality of protrusions provided at said support structure, and cutting edges provided intermediate neighbouring protrusions.

The cutting means according to some aspects of the present invention may be made in any material that is suitable for cutting a web of material. Such a material may e.g. be metal, metal alloys, or plastic. Certain dispensers may be intended for use during a long time, while others are disposable. The important aspect when choosing material is that it should be able to maintain a desired sharpness during the intended life time of the dispenser in which it is intended to be used. Furthermore, it is not necessary that the entire cutting means are in the same material, it is e.g. possible to consider alternative embodiments in which the protrusions are made of one material and the cutting edges are of a different material.

As is evident for someone skilled in the art, the above described exemplary embodiments may be combined with each other, in any feasible manner. Each of the different aspects of the invention described above provides for an improved arrangement for tearing or cutting off web material from a centre-fed roll. Hence, the different aspects of the invention may independently of each other provide useful arrangements within the object of the invention. However, as is evident for someone skilled in the art, it is also possible to combine different aspects of the invention with each other as well as combining described exemplary embodiments within one aspect of the invention with exemplary embodiments described in other aspects of the invention.

Other objectives, features and advantages will appear from the following detailed disclosure, from the attached dependent claims as well as from the drawings.

### BRIEF DESCRIPTION OF THE DRAWINGS

The present invention will now be described, for exemplary purposes, in more detail by way of embodiments and with reference to the enclosed drawings in which:

FIG. 1 is a schematic illustration of a dispenser in both an exploded view and in an assembled view, being provided with cutting means according to one aspect of the present invention,

FIG. 2 is a partial cross-sectional view of a dispenser being provided with cutting means according to aspects of the present invention,

FIGS. 3a and 3b are perspective views of alternative embodiments of protrusions to be used in the cutting means according aspects of the present invention,

FIGS. 3c and 3d are front views of alternative embodiments of protrusions to be used in the cutting means according to aspects of the present invention,

FIGS. 3e, 3f and 3g are side views of alternative embodiments of protrusions to be used in the cutting means according to aspects of the present invention,

FIGS. 3h and 3i are top views of alternative embodiments of protrusions to be used in the cutting means according to aspects of the present invention,

FIGS. 4a-4d are partial schematic cross-sectional views illustrating the main steps of dispensing and cutting a web in accordance with aspects of the present invention,

FIG. 5 is a schematic perspective illustration of a dispenser being provided with an alternative embodiment of cutting means,

FIGS. 6a, 6b and 6c are exploded perspective views of an embodiment of a dispenser being provided with cutting means according to aspects of the present invention,

FIG. 7 is a perspective view of cutting means being provided with friction generating means according to aspects of the present invention.

### DETAILED DESCRIPTION OF PREFERRED EMBODIMENTS

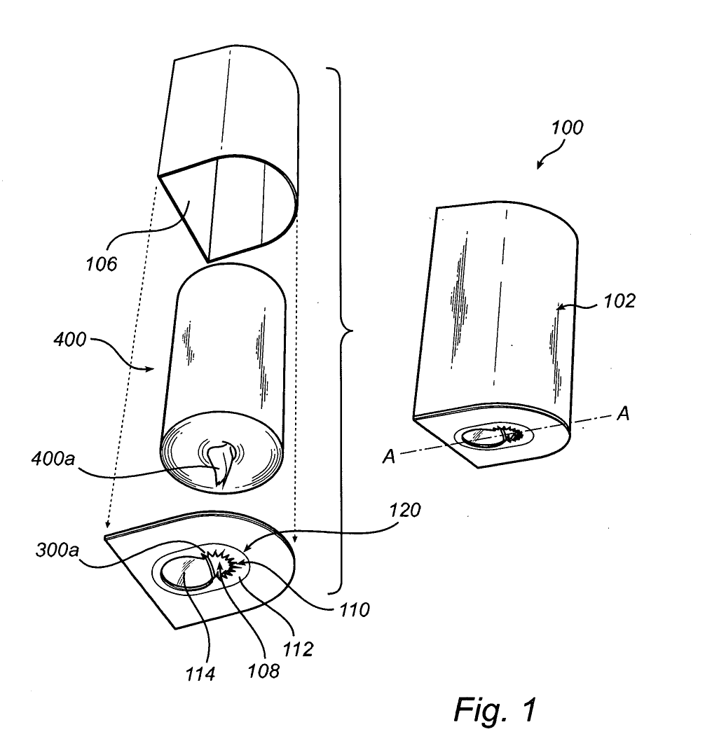

FIG. 1 schematically illustrates a dispenser for a centre-fed roll of web material according to an embodiment of the invention.

The dispenser 100 comprises a housing 102 adapted to accommodate a centre-fed roll 400 of web material, such as tissue paper or non-woven material. The view to the left in FIG. 1 illustrate an exploded view of the dispenser 100 and the view to the right illustrate an assembled view.

The illustrated dispenser 100 has a flat rear wall 106 enabling the dispenser to mounted to a surface, such as e.g. a wall, wherein the housing 102 supports the web roll 400 in an upright position. An opening 108, here arranged at the bottom end of the dispenser 100, enables extraction of web from the web roll. Furthermore, cutting means 110 is arranged at the opening or trough-hole 108 permitting dispensed or extracted web to be cut off at a desired length. In this embodiment, the cutting means 110 has a semi-circular shape partially enclosing the opening 108. Protrusions 202 are extending from the perimeter of the opening and in the direction towards the centre of the opening. To enable a user to grip the web with his thumb, the opening may typically have a diameter about 25 mm measured between the tips of two protrusions on opposite sides of the opening.

In this embodiment, the base surface 112 of the cutting means is arranged in the same plane as the bottom of the dispenser and the web is thereby intended to be cut at this plane. Thus, in order to facilitate access to the free end 400a of the web the next time it is desired to extract a portion of the web from a dispenser, it may be beneficial if it is provided for the user to grip the web at a level above the base surface of the cutting means. This can be achieved by a cup 114 provided so that its convex side extends into the dispenser. The cup 114 here has the shape of the upper portion of a sphere, but have a cut-out or opening facing the cutting means 110 so that a user may insert one or a couple of fingers and make contact or grab the web above the cutting plane of the cutting means. The cup 114 may, for example, have a diameter of 40 mm and extend about 20 mm into the dispenser.

Although the arrangement with a cutting means and an access cup may be an integral part of the dispenser, it may also be provided separately as a complementary device which can be mounted to the dispenser. Furthermore, the cutting means 110 may be provided as one separate component and the globe 114 as one separate component. The cutting means being provided as a complementary device that may be mounted to a dispenser may be considered an extracting means 120. The extraction means 120 may then comprise a structure on which the cutting means 110 are arranged and an opening 108 through which the web may pass. In certain embodiments, the extraction means 120 may also comprise the cup 114 enabling access to a portion of a web above the cutting plane of the cutting means.

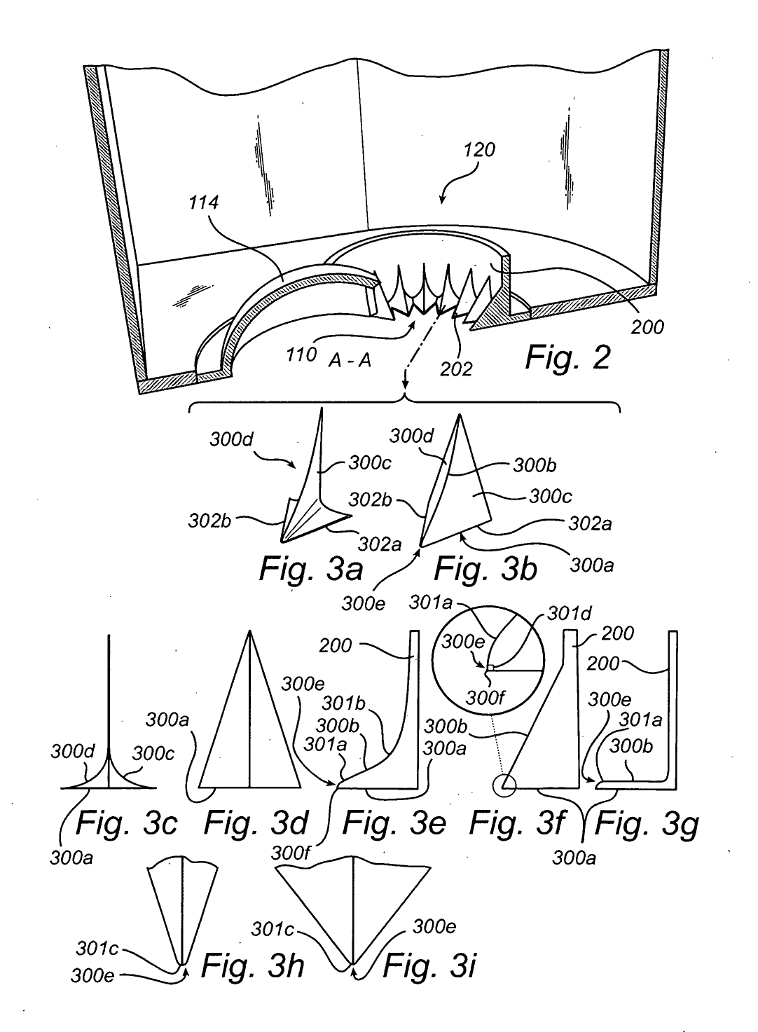

The cutting means 110 will now be described in more detail with reference to FIG. 2, being a cross section along the line A-A in FIG. 1, and FIGS. 3a-3i schematically illustrating exemplifying embodiments of protrusions or teeth, seen from different perspectives, that extend from a support structure of the cutting means 110.

As is seen in FIG. 2, the cutting means 110 comprises a support structure 200. The support structure 200 has a semi-circular shape partially enclosing the opening 108. In this embodiment, the support structure 200 has a height extending towards the interior of the dispenser 100. The height of the support structure 200 may preferably be between 6 mm and 40 mm, and more preferably between 10 and 20 mm. A lower support structure enables a more compact dispenser, whereas a higher support structure may reduce the risk that the paper falls out of the support structure and becomes inaccessible for the user. In the illustrated example, the height of the support structure is 12 mm.

The support structure 200 is provided with a plurality of ridge-shaped protrusions 202. In the illustrated example, all protrusions 202 have the same size and shape and forms an uninterrupted or continuous row of protrusions. The distance between adjacent tips are preferably between 3-10 mm, more preferred 8-4 mm. In the illustrated example distance between the tips are 5 mm. Thus in this embodiment the cutting means comprises eleven protrusions 202 in total.

Each protrusion has a base surface 300a and a slide surface 300b which are here connected by first 300c and second 300d side surfaces. The four surfaces 300a-d meets in a tip 300e pointing towards the centre of the opening 108. The slide surface 300b typically is arranged to face web path, i.e. the path the web follows as it is extracted from the dispenser. The slide surface may take on many different shapes and extensions. The purpose of the slide surface is that the web material shall be able to slide on it without being cut, torn or ripped, as it is being dispensed from a dispenser. Here, the slide surface 300b is in the form of narrow edge. The width of the slide surface may e.g. be in the range of 0.2-1.2 mm. However, in order for the web material to be able to slide or glide on the slide surface, it is important that the edge is not too sharp so that it tears or damages the paper. Hence, it may for example have a slightly convex shape or rounded edges connecting it to the respective side surfaces.

In FIG. 2 the protrusions 202 are of the shape that is more clearly illustrated in FIG. 3b. In this embodiment, the slide surface 300b extends along a straight line between the support structure 200 and the tip 300e of the protrusion, where it connects to the base surface 300a. The angle between the base surface and the slide surface may preferably be between 10° and 90°, more suitable between 20° and 70° and most suitable between 60° and 70°. In the embodiment illustrated in FIGS. 2, 3b and 3f, the angle between the base surface and the slide surface is 65°.

As an alternative, which is schematically illustrated in FIG. 3e, the slide surface 300b may have a concave shape 301b, i.e. being curved towards the base surface. Such a protrusion, having the shape of a ski slope, may provide enhanced ergonomics and improve the user experience.

According to another alternative embodiment schematically illustrated in FIG. 3g, the slide surface 300b extends substantially parallel with the base surface 302a and it is only the portion of the slide surface closest to the tip portion that has a rounded shape. The rounded shape in the embodiment of FIG. 3g is a convex curvature in a plane perpendicular to the plane of the base surface and to the plane of the support structure. This rounded shape of the slide surface adjacent its connection to the base surface is also present in the other embodiments illustrated in FIGS. 3e and 3f.

In FIG. 2, and in the different alternatives illustrate in FIGS. 3a-3i, the base surface 300a extends substantially perpendicularly to the support structure, wherein the base surface 300a faces away from the dispenser. The deviation from the substantially perpendicular relationship between the base surface and the support structure is preferably less than 5° in either direction, more preferred less than 3° in either direction and most preferred less than 1° in either direction.

The base surface 300a of each of the exemplified protrusions has the shape of an isosceles triangle with an angle at the tip of the protrusion in the range 35° to 75°, more preferably in the range 45° to 65°, and most preferred 55°. The angle referred to is as seen in the plane of the base surface, i.e. as seen from above or below the base surface and is best illustrated by the top views in FIG. 3h and FIG. 3i.

A cutting edge 302a,b is provided at a portion of the base surface 300a in each of the exemplified protrusions in FIGS. 3a-3i. The cutting edge 302a,b is formed at the intersection between each side surface 300c, 300d and the base surface 300a. Hence, each protrusion has have two cutting edges 302a,b, one on each side of said base surface, as seen from the tip of the protrusion. When studying a protrusion from a side view, as in FIGS. 3e, 3f and 3g, the tip portion will be provided furthest away from the support structure and thereafter the cutting edge will follow. Hence, the cutting edge or cutting edges on one or each of said sides extend between the support structure 200 and the tip portion 300e.

The side surfaces 300c-d may have a straight or planar extension from the slide surface 300b to the base surface 300a as illustrated in FIGS. 3b and 3d. As an alternative, the side surfaces may be provided with a concave shape, as exemplified by the illustrations in FIG. 3a and FIG. 3c.

The tip 300e of each protrusion 202 has a rounded shape in one or several dimensions. However, the tip is not completely round or spherical, which will be explained in greater detail below. As illustrated by FIGS. 3h and 3i showing a top view of the protrusion 202 (i.e. looking from inside the dispenser in a direction out through the opening) the tip 300e of each protrusion can be rounded in the plane of their respective base surfaces.

The tip may also be rounded in a plane perpendicular to the plane of the base surface. This means that the tip is rounded as seen from the side of one of the protrusions. This is illustrated by FIGS. 3e, 3f and 3g showing a side view of exemplary protrusions. The curvature 301a, as best seen in FIGS. 3e, 3g and the magnification of FIG. 3f, of the rounded tip in the plane perpendicular to the base surface is a convex curvature. Hence, the rounded tip has its rounded surface pointing in the extension direction of the protrusion, as seen from the support structure.

In the embodiment illustrated in FIG. 2, the tip of each of the protrusions are rounded both in the direction as illustrated by FIGS. 3h and 3i, i.e. rounded in the plane of the base surface, and in the direction illustrated in FIGS. 3e, 3f and 3g, i.e. in a plane that is perpendicular to both the plane of the base surface 300a and to the plane of the support structure 200.

However, although the tip 300e has a rounded shape, the slide surface 300b meets the base surface 300a at an angle 301d being 90°. This is best seen in the magnification of FIG. 3f and is illustrated as edge 300f, but it is provided in the same manner in the other exemplified protrusions in FIG. 3. Hence, when the slide surface 300b has a convex curvature 301a, the curve is preferably arranged so that the slide surface meets the base surface with a substantially right angle. Through this arrangement, the bottom portion of the tip forms a sufficiently sharp angle (i.e. between the base surface and the slide surface) so that the web is hooked on to this angle when a user pulls the web towards the cutting edge. This will be explained in greater detail below.

Whereas the cutting means should be able to cut paper, a user should be able to touch the cutting means, press a finger against the cutting means, and draw a finger along the cutting means without discomfort or risk of being hurt. This can be achieved by an appropriate combination of a set of design parameters which to some extent depends on each other. Typical design parameters are: the distance between neighbouring tips, the angle of slide surface in relation to base surface, and the radius of the curvature of the tip. The parameter combinations of three exemplary embodiments will now be described below. In each of the three exemplary embodiments the base surface of each of the protrusions is provided as an isosceles triangle with an angle at the tip of the protrusion here being 55°.

According to a first exemplary embodiment, the distance between adjacent or neighbouring tips are 5 mm. The curvature 301c of each of the tips in the plane of their respective base surfaces has a radius of 0.6 mm. The curvature 301a at the slide surface adjacent its connection to the base surface, i.e. the curvature in a plane perpendicular to the base surface, has a radius of 0.4 mm. The angle between the slide surface and the base surface is approximately 65°. The slide surface has, except for the curvature 301a adjacent its connection to the base surface, a straight extension from the tip to the support structure. The side surfaces of each of the protrusions in this embodiment are preferably concave.

According to a second exemplary embodiment, the distance between adjacent or neighbouring tips are 3 mm. Due to the fact that these tips are closer together than in the first exemplary embodiment, the radius of the tip in the plane of the base surface and the angle between the base surface and the slide surface may be smaller without compromising the safety or experience of the user. Hence, in this case, the curvature 301c of each of the tips in the plane of their respective base surfaces may have a radius of 0.2 mm. The angle between the slide surface and the base surface may be between 30° and 50°. The curvature 301a at the slide surface adjacent its connection to the base surface has also in this exemplary embodiment a radius of 0.4 mm.

According to a third exemplary embodiment, the distance between adjacent or neighbouring tips are 7 to 8 mm. Due to the fact that these tips are further apart than in the first and second exemplary embodiments, the radius of the tip in the plane of the base surface and the angle between the base surface and the slide surface are preferably larger than those mentioned above. Hence, in this case, the curvature 301c of each of the tips in the plane of their respective base surfaces may have a radius of approximately 1 mm. The angle between the slide surface and the base surface may be between 50° and 80°. The curvature 301a at the slide surface adjacent its connection to the base surface has also in this exemplary embodiment a radius of 0.4 mm.

The cutting means 110 may be made in any material that is suitable for cutting a web material. Such a material may e.g. be metal, metal alloys, or plastic. Certain dispensers may be intended for use during a long time, while others are disposable. The important aspect when choosing material is that it should be able to maintain a desired sharpness during the intended life time of the dispenser in which it is intended to be used.

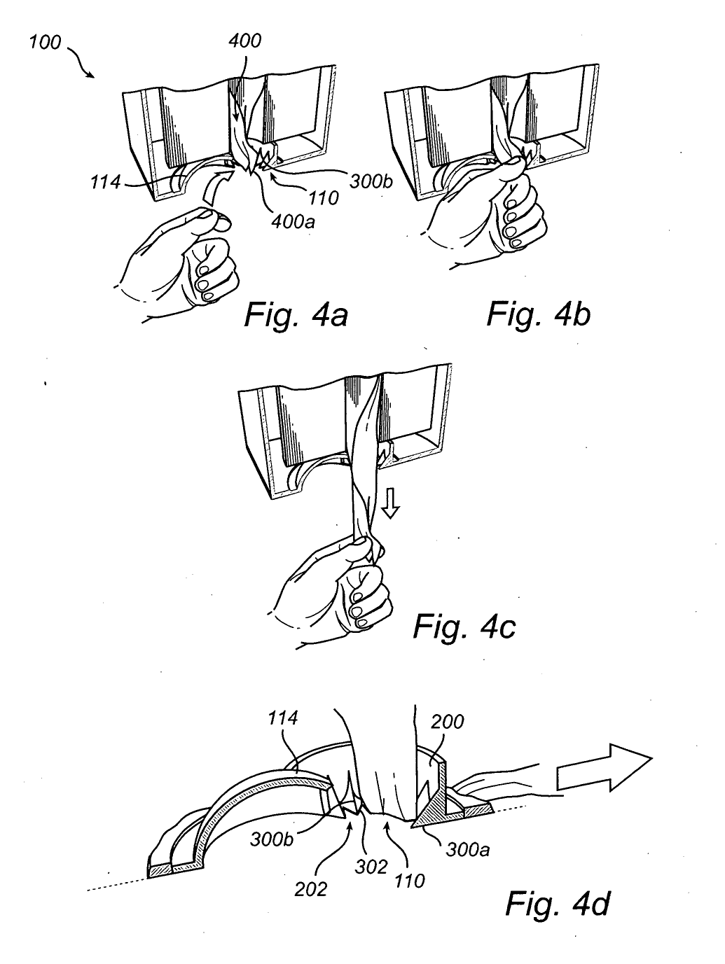

FIG. 4 schematically illustrates the function of a dispenser according to an embodiment of the invention. A dispenser 100 is provided with a roll of web material 400. The web 400 has been cut before by the cutting means 110. As is seen in FIG. 4a, the cutting edges of the cutting means 110 has cut the web 400 at the plane of the base surface 300a of the protrusions 202. In order for a user to access the web 400 the next time it is desired to extract a portion of the web from the dispenser 100, it is provided for the user to grip the web at a level above the base surface of the cutting means. It is here facilitated by the cup 114 having a cut-away portion that gives access to the opening where the web 400 exits the dispenser.

Thus, as illustrated in FIG. 4b, the user puts his thumb into the cup 114 and moves it to the cutting means above the base surface thereof, to get hold of the free end 400a of the web 400 or to push it towards the slide surfaces of some of the protrusions 202. Hence, a user may only need to insert one finger into the cup and the cutting means. By a sliding movement of the finger against the slide surfaces 300b, pressing the web between the finger and the slide surfaces, the web is brought along. Once a sufficient length of the web has been brought outside the cutting means, the user may then grabs the web 400, as illustrated in FIG. 4c. He or she may thereafter extract the web from the dispenser 100 by pulling the free end of the web downwards as illustrated in FIG. 4c. As the web 400 is pulled straight out of the dispenser 100 and through the cutting means, it slides on the slide surfaces 300b of some of the protrusions 202.

Next, the user pulls the web towards the cutting edges 302 of the cutting means 110 (right in the illustration) to cut it off. This is illustrated in FIG. 4d. At this stage it is desirable that the path of the web obtains a sharp angle in relation to the edge 300f. By this, the web will easier be hooked on the rounded tips 300e and the edge 300f of the protrusions and the risk that the web slides on the tips of the protrusions is diminished. A sharp angle of the path of the web can be achieved by having the web exit the dispenser in a close relationship to the protrusions of the cutting means. This can be provided by using a sufficiently small diameter of the opening which is here defined by the semi-circular support structure 200 and the cup 114.

As the web is hooked on the rounded tips 300e and the edge 300f of the rounded tips, and the user keeps pulling the free end of the web, the web will be somewhat ripped or torn apart and inserted between the protrusions and thereby become cut by the cutting edges 302 arranged intermediate the protrusions.

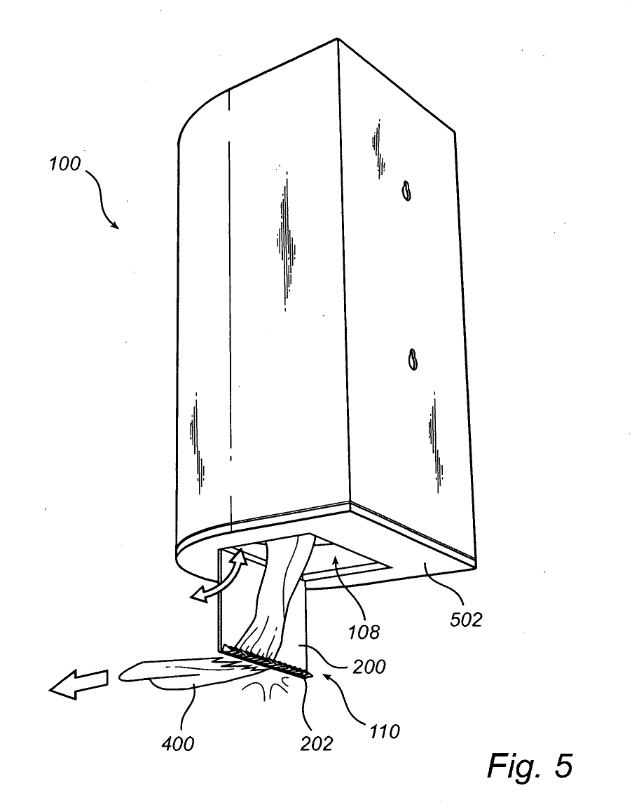

FIG. 5 schematically illustrates an alternative embodiment of a dispenser 100 provided with cutting means 110 that are pivotally or foldable arranged in relation to the dispenser. The support structure 200 here as a straight or only slightly bent surface, and the protrusions are provided on that side of the support structure 200 that is facing towards the dispenser 100 when the support structure is folded towards the bottom surface 502 of the dispenser. It is then, on the one hand, possible to provide the cutting means so that they extend below the bottom surface 502 of the dispenser when the dispenser is in use, as is illustrated in FIG. 5. On the other hand, it is possible to fold the support structure 200 towards the bottom surface 502. Thus, the support structure 200 may cover the opening 108 of the dispenser when it is folded towards the bottom surface 502. An advantage is that the protrusions may be folded to a not in use position where there is less risk that the protrusions are damaged, and also less risk that a user hurts himself or herself on them. Another advantage is that if the hole or opening of the dispenser is covered when it is not in use, there is less risk that unwanted substances, such as water, dust or dirt, enters into the dispenser.

In this embodiment, since the protrusions of the cutting means are well below the bottom surface 502 of a dispenser, it is not necessary to provide a cup or globe in order to be able to access the web above the plane in which the web is cut. Instead the user may easily access the web between the bottom surface 502 and the cutting plane of the cutting means 110.

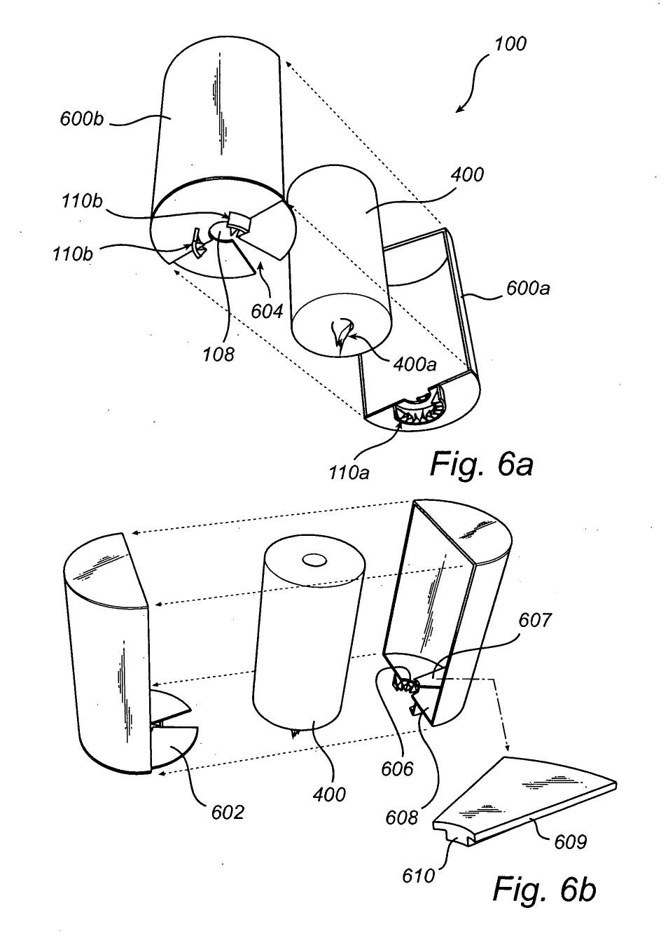

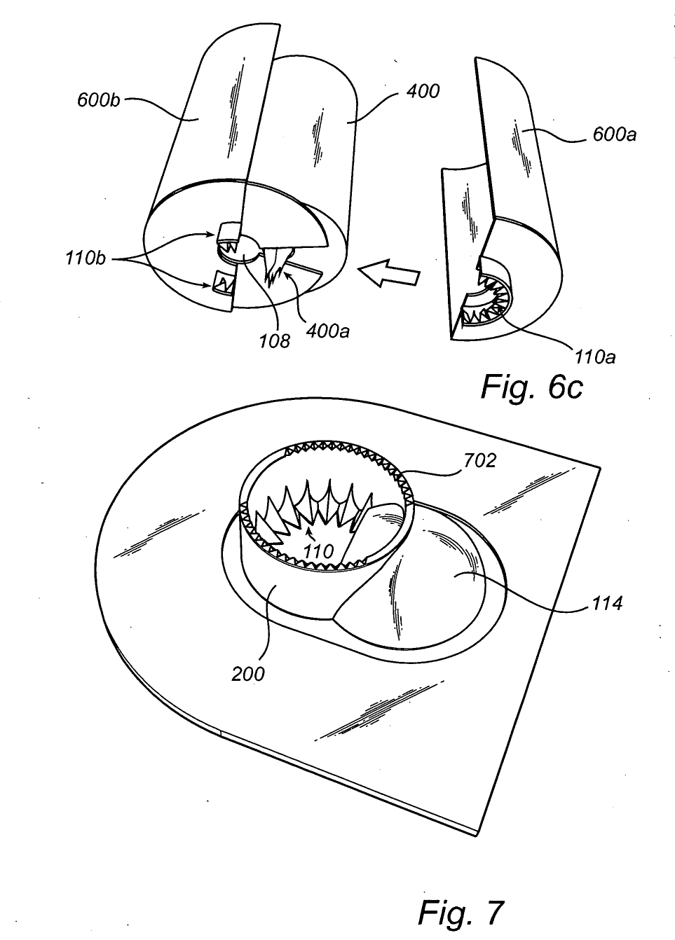

FIGS. 6a, 6b and 6c schematically illustrate a dispenser 100 comprising first 600a and second 600b complementary housing parts adapted to be engaged to form a housing for accommodating a web roll 400.

The second complementary housing part 600b is here provided with a base structure 602 arranged to support the roll 400 of web material in an upright position. An opening 108 for enabling extraction of the web 400 from the web roll in the housing is provided in the base structure 602, and a recess 604 extends from the opening 108 to a periphery of the base structure 602. The recess 604 here has a narrowing shape towards the opening 108.

Here, a first portion of the cutting means 110a is provided at the first complementary part 600a of the housing and a second portion of the cutting means 110b is provided at the second complementary part 600b of the housing.

The complementary parts 600a-b of the dispenser are here divisible along a parting plane extending through the opening 108 through which the web 400 may be extracted from the dispenser 100 and through the cutting means 110. By this, it is possible to provide for opening of the dispenser and dividing of the cutting means 110 simultaneously.

This embodiment facilitates loading of a new roll of paper into the dispenser since a user may extract a small piece 400a of the web from the roll and guide it through the recess 604 and into the opening 108 at the same time as the roll 400 is being arranged on the surface 602 of the dispenser that is intended to support the roll 400. This facilitates the guiding of the web into the opening. The opening 108 is, as described above in relation to FIG. 4, rather small and it is therefore beneficial to not have to guide the paper trough the opening 108 as the user inserts a new roll into the dispenser, which is often the case with previously known dispenser. Once the roll of web is in place, the complementary parts 600a-b of the housing may be brought together, and since the cutting means are provided at one or both of the complementary parts of the dispenser, the cutting means 110 becomes arranged at their in use position. By this arrangement it is possible to load a new roll of web straight into the dispenser, without having to incline the roll against its in use position, as is often the case with prior art dispensers when trying to guide the small piece 400a of the web trough the opening 108. This is beneficial since it reduces the height that is necessary for the housing of the dispenser. Furthermore, it is easy to position the free end 400a of the web in the opening 108 leading from the dispenser to the cutting means.

The dispenser also comprises means for locking the two complementary parts of the housing together. In the illustrated embodiment these means are constituted of a fastening member 607 provided at a bottom surface 608 of one of the housing parts. The fastening member comprises a top portion 609 that is connected to the bottom surface 608 by an intermediate portion 610 having a smaller width than the top portion of the fastening member. Hence, the face of top portion 610 extending towards the bottom surface 608 of the housing is not in contact with the bottom surface 608. As is also seen in FIG. 6b, the top portion of the fastening portion 607 has a shape corresponding to the recess 604 of the base structure of the other complementary housing portion but is somewhat larger. Hence, when the complementary housing portions are brought together, the fastening member may slide into the recess and the edges of the recess becomes positioned between the top portion 610 of the fastening member and the bottom surface 608 to which the fastening member is connected. Thereby, the complementary parts of the housing becomes connected to each other. Other suitable connection or fastening means such as hooks and corresponding recesses, Velcro-fasteners or hooks and elastic members are of course also conceivable.

As web is pulled out of a centre-fed web roll one may experience a frictional resistance since the web is packed together in the roll. The highest frictional resistance is typically experienced for a full roll, and as web is consumed the frictional resistance tend to diminish. In a typical application, the frictional resistance has been substantially reduced when 20-30% of the web roll has been consumed. The resistance in the web roll is of interest since it will be easier to cut off the web against the cutting means if a desired level of friction is present. It may thus be advantageous to compensate for the reduced frictional resistance in the web roll.

According to one embodiment, illustrated in FIGS. 6a, 6b and 6c, the dispenser is provided with an opening 108, through which the web 400 passes as it is being extracted from the dispenser 100, wherein the diameter of the opening 108 is provided so that the web material comes into contact with an edge 606 surrounding the opening 108 as it is being extracted from the dispenser, whereby friction is generated between the web 400 and the surface surrounding the edge 606.

The friction generated by the friction means, i.e. between the edge and the web in this embodiment, tend to increase as the web is consumed in the roll. When a full roll has been loaded in the dispenser, and the free end of the web is pulled straight out from a full roll, the web path will be in a direction essentially parallel to the axial direction of the roll. However, as more and more web is consumed the web path will be gradually tilted in relation to the axial direction of the roll. As a consequence, there will be an increased contact and pressure between the edge 606 of the opening 108 and the web 400 when web is extracted from the dispenser, thereby providing enhanced friction.

A friction between the web 400 and the opening 108 is beneficial since it further enhances the possibility of stopping or hooking the web 400 onto the protrusions of the cutting means 110 when a user intends to cut the web.

In the embodiment illustrated in FIGS. 6a, 6b and 6c, the cutting means 110 is arranged underneath the bottom of the dispenser. However, as illustrated in e.g. FIGS. 2 and 7, the cutting means may also be arranged inside the dispenser 100, e.g. in such a way that the cutting edge of the cutting means 110 is in the plane of the bottom surface of the dispenser. If so, the top surface 702 of the support structure 200 may be used to generate the desired friction. This generating of friction may e.g. be achieved as described in relation to FIGS. 6a, 6b and 6c, i.e. by the contact of the web and the edge of the top surface of the support structure circumscribing the opening 108.

As illustrated in FIG. 7, the friction may be further enhanced by providing a set of projections or grooves at the top surface 702 of the support structure 200. The friction may also be enhanced by providing a material that generates more friction, such as, e.g. silicone, on the top surface 702 of the support structure 200 or the surface adjacent the edge 606 adjacent the opening 108. The friction increasing means could be provided throughout the top surface of the support structure, or at a portion of the upper surface of the support structure. In the embodiment illustrated in FIG. 7, there are no projections on the portion of the support structure where a user typically introduces the free end of the web when loading a new roll into a dispenser.

Another alternative in order to provide means that increases the friction is that the edge 606 surrounding the opening 108 is a sharp edge, e.g. an edge of approximately 90°. When the web is to enter the opening 108, it will come into contact with this sharp edge and a sufficient increase in friction may be achieved.

The cutting means, the extraction means and the dispenser has been described in relation to some exemplary embodiments. However, several modifications and adaptations are possible within the scope of the present invention as defined in the appended claims.

1. A cutting device for use with a dispenser for a centre-fed roll of web material, said cutting device comprising:
a support structure;
a plurality of protrusions provided at said support structure,
wherein at least some of said plurality of protrusions has a rounded tip and neighbours at least one other protrusion having a rounded tip; and
a cutting edge provided between said rounded tips of said neighbouring protrusions.

2. The cutting device according to claim 1, wherein each protrusion has a base surface and a slide surface, wherein said slide surface extends from said support structure to a point on said base surface most remote from said support structure.

3. The cutting device according to claim 1, wherein the cutting edge is provided at a portion of said base surface.

4. The cutting device according to claim 2, wherein said plurality of protrusions further comprises first and second side surfaces connecting said slide surface with said base surface, wherein said cutting edge is provided at the intersection between at least one of said side surfaces and said base surface on each protrusion.

5. The cutting device according to claim 1, wherein the rounded tip of the protrusion has a curvature in the plane of the base surface, said curvature having a radius in the range of 0.2-1.2 mm, more preferably in the range of 0.4-0.8 mm and most preferably 0.6 mm.

6. The cutting device according to claim 1, wherein the rounded tip of the protrusion has a curvature in a plane perpendicular to the plane of the base surface, said curvature having a radius in the range of 0.2-1.2 mm, more preferably in the range of 0.3-0.8 mm, and most preferred 0.4 mm.

7. The cutting device according to claim 2, wherein an edge formed between the slide surface and the base surface at the tip of the protrusion has an angle being in the range 45°-95°, more preferably 85°-95°, and most preferred 90°.

8. The cutting device according to claim 2, wherein a distance between said slide surface and said base surface decreases continuously from the support structure to the tip of the protrusion.

9. The cutting device according to claim 2, wherein the slide surface has a general extension that is angled with respect to the base surface, wherein the angle between the base surface and the slide surface is in the range 10° to 90°, more preferably in the range 20° to 70° and most preferred in the range 60° to 70°.

10. The cutting device according to claim 2, wherein the base surface of each of the protrusions has the shape of an isosceles triangle with an angle at the tip of the protrusion in the range 35° to 75°, more preferably in the range 45° to 65°, and most preferred 55°.

11. The cutting device according to claim 4, wherein each of said side surfaces is provided with a concave shape.

12. A paper extraction device comprising an opening for leading through web material from a centre-fed roll, and cutting device according to claim 1.

13. A dispenser for a roll of web material comprising:
a housing for accommodating the roll, wherein the housing has a through-hole for enabling extraction of the web material from said housing; and
a cutting device according to claim 1, wherein said cutting device is arranged at said opening in such a way that said web material may be cut off by said cutting device.

14. The dispenser according to claim 13, wherein said dispenser is provided with a through-hole, through which the web material passes as it is being extracted from said dispenser, wherein the diameter of said through-hole is provided so that the web material comes into contact with an edge of the through-hole as it is being extracted from said dispenser, whereby friction is generated between the web material and the edge.

15. The dispenser according to claim 13, wherein said cutting device is arranged in such a way that the web exits the dispenser in a close relationship to the protrusion of the cutting device, so that the web material is in contact with at least some of the slide surfaces of said cutting device.

16. The dispenser according to claim 13, wherein said cutting device is configured to allow a user to grip the web material at a level above the base surface of the cutting device.

17. The dispenser according to claim 13, further comprising two complementary parts adapted to be engaged to form said housing and disengaged to enable a roll of web material to be inserted in said housing, wherein one of said complementary parts is provided with a base structure, wherein said opening for enabling extraction of the web material from said housing is provided in said base structure, and a recess extends from said opening to a periphery of said base structure.
